(19) United States
(12) Patent Application Publication
(10) Pub. No.: US 2016/0294149 A1
(43) Pub. Date: Oct. 6, 2016

(54) ULTRA-SHORT PULSE MID-IR MODE-LOCKED LASER

(71) Applicant: IPG PHOTONICS CORPORATION, Oxford, MA (US)

(72) Inventors: Sergey VASILYEV, Birmingham, AL (US); Michael MIROV, Birmingham, AL (US); Valentin GAPONTSEV, Worcester, MA (US)

(21) Appl. No.: 15/085,327

(22) Filed: Mar. 30, 2016

Related U.S. Application Data
(63) Continuation of application No. PCT/US2014/055805, filed on Sep. 16, 2014.
(60) Provisional application No. 61/884,650, filed on Sep. 30, 2013.
(60) Provisional application No. 61/884,842, filed on Sep. 30, 2013.

(51) Int. Cl. H01S 3/094; H01S 3/08; H01S 3/081; H01S 3/00; H01S 3/13; H01S 3/16; H01S 3/06

(52) U.S. Cl. CPC H01S 3/094026; H01S 3/1628; H01S 3/162; H01S 3/08004; H01S 3/0612; H01S 3/0014; H01S 3/1305; H01S 3/0815

(57) ABSTRACT

A short-pulse mode-locked laser is configured with at least two reflective elements defining a resonant cavity therebetween, a laser gain element (“GE”) placed inside the resonant cavity at normal incidence and selected from transition metal doped II-VI materials; and an optical pump emitting pulsed output to synchronously or quasi-synchronously pump the GE at a pulse repetition rate frequency fₚᵤₘₚ, the pump being configured so that the fₚᵤₘₚ substantially matches an inversed round trip time in the resonant cavity fₗₐₛₑᵣ:fₚᵤₘₚ≈fₗₐₛₑᵣ=c/2L, where c is the speed of light, L is the length of the resonant cavity. The synchronous or quasi-synchronous pumping triggers and sustains a short-pulse emission of the laser with picosecond or femtosecond pulse durations.

### SUMMARY OF THE DISCLOSURE

1. Field of The Invention

The present invention relates generally to a gain media configured with II-VI chalcogenides which are doped with transition metals (“TM:II-VI”). More particularly, the disclosure relates to mid-IR solid state mode locked lasers and optical amplifiers all based on TM:II-VI gain media and operative to emit picosecond and femtosecond pulses in a 1.8-8 μm spectral range.

2. Prior Art Discussion

Pulsed lasers have a great potential for applications in various fields, such as optical signal processing, laser surgery, bio-medicine, optical diagnostics, two-photon microscopy, optical probing, optical reflectometry, laser spectroscopy, material processing, etc. There are two main classes of pulsed lasers, namely Q-switched lasers and mode-locked lasers with the latter being of a particular interest for this disclosure.

Mode-locked lasers can produce ultra-short optical pulses at high repetition rates. As is known in the art, a mode-locked laser has multiple longitudinal modes that oscillate simultaneously with their respective phases locked to each other at a fixed relationship. In order to achieve mode locking, a mode-locking mechanism is required to synchronize the phases of the lasing modes so that the phase differences among all lasing modes remain constant. These optically phase-locked modes then interfere with each other to form short optical pulses.

Two broad classes of mode-locking schemes include active mode locking and passive mode locking, which is the scheme of interest in the present application, are typically used. Various methods and devices are known in the art for implementing both schemes.

The Passive mode-locking schemes use at least one nonlinear optical element or device in the laser cavity, or within a cavity external, but optically coupled, to the laser cavity. Such a nonlinear optical element possess an intensity-dependent response to favor optical pulse formation over continuous-wave lasing and, thus, operates as a mode-locker in a passively mode-locked laser. The properties of the mode locker may include amplitude nonlinearity (absorption as a nonlinear function of input optical intensity), Kerr-type (phase or refractive index as a nonlinear function of input optical intensity) nonlinearity, or a combination of both to facilitate mode locking.

Amplitude nonlinearity could be provided by a saturable absorber with a fast recovery lifetime in the order of picoseconds. The saturable absorber is made from material that displays a change in its optical transparency dependent on the incident optical intensity in a specific operating wavelength region. In a linear regime, where the incident optical intensity is weak, the saturable absorber absorbs the incident light resulting in attenuation of the optical intensity of the incident light. When the incident optical intensity is raised to a higher level, the saturation of absorption occurs and the absorption by the saturable absorber decreases which leads to a decrease in attenuation of the optical intensity of the incident light. This kind of intensity-dependent attenuation allows the high intensity components of the pulse to pass through but not the low intensity components, such as the pulse wings, pedestals and background continuous wave (“CW”) radiation. When a saturable absorber is placed in a lasing cavity, it will favor the pulsed regime over the CW regime of laser operation.

An example of suitable absorbers includes the SESAM (semiconductor saturable absorber mirror), which is widely used in the known mode-locked crystalline lasers disclosed, among others, in papers authored by I. T. Sorokina et. al., and including “A SESAM passively mode-locked Cr:ZnS laser”, Optical Society of America, 2005; “Sensitive Multiplex Spectroscopy in the molecular fingerprint 2.4 μm region with a Cr²:ZnSe femtosecond laser” Optical Society of America, 2007. This paper is fully incorporated herein by reference.

The SESAM requires complex and costly fabrication systems. It further may require an expensive hermetic packaging for a long-term environmental stability and may not withstand high optical powers. In operation, short-pulse lasers of the type disclosed here and based on the SESAM demonstrate certain instability limitations which are attributed to temperature increase of the SESAM heatsink. Also, at strong focusing, the undesirable multi-pulse operation regime may be observed possibly due to the two-photon absorption in the SESAM.

Alternatively, Kerr-type nonlinearity, and the Kerr-lens method (Kerr-focusing, self-focusing and further referred to as Kerr-Lens Mode-lock (KLM) is the phenomenon intrinsic to TM:II-VI materials. It is used to provide an ultra-fast laser mode-locking mechanism. Although not a saturable absorber, the non-linear optical properties such as the Kerr effect give an artificial “saturable absorber” effect, which has a response time much faster than any intrinsic saturable absorber.

The schemes of mode-locked lasers utilizing the KLM mechanism have been demonstrated. The particular advantage of such schemes stems from the very fast response and the fact that no special saturable absorber medium is required. Reliability and reproducibility of ultrafast TM:II-VI lasers depend on the availability of gain elements with high optical quality and uniformity of the laser properties. Until very recently, it was widely believed that KLM regime in TM:II-VI lasers requires the use of single crystal gain medium in which the crystal lattice of the entire sample is continuous and unbroken to the edges of the sample, with no grain boundaries. The term “gain media” as used throughout the specification refers to an optical component which produces optical fluorescence and is capable of amplifying an optical signal in the same wavelength range as the optical fluorescence. Currently, high quality TM:II-VI single crystal materials are not readily available. Crystal sublimation during the growth process results in poor uniformity of the single-crystal samples and limits the dopant concentration. It is often required to locate a ‘good spot’ inside the single crystal in order to achieve KLM regime of the laser. Hence, considering the cost and often questionable quality of TM:II-VI laser materials in single crystals, even a possibility of mass production of this type of lasers was given little or no consideration.

Recently obtained results, however, encourage the use of polycrystalline TM:II-IV materials, which are often referred to as ceramic, in ultra-fast pulsed lasers. The important advantage of polycrystalline TM:II-VI laser materials over single crystal-based structures is the post-growth diffusion doping—technology which enables mass production of large-size laser gain elements with a high dopant concentration, uniform dopant distribution, and low losses.

II-VI materials (ZnSe, ZnS, ZnTe, etc.) exhibit rather high second-order nonlinear susceptibility, which is comparable or exceeds the values of standard nonlinear materials such as lithium niobate, ammonium dihydrogen phosphate, potassium dihydrogen phosphate (KDP). Polycrystalline structures allow for randomly quasi-phase-matched three-wave mixing (effects known as second harmonic generation, sum frequency generation, difference frequency generation and optical rectification respectively) [M. Baudrier-Raybaut, R. Haidar, Ph. Kupecek, Ph. Lemasson and E. Rosencher, “Random quasi-phase-matching in bulk polycrystalline isotropic nonlinear materials”, Nature 432, 374-376 (2004)]. The post-grown doping technology provides the possibility of controlling (to some extent) the polycrystalline TM:II-VI laser gain media microstructure and hence tailoring the parameters of the gain element in favor of a certain type of the three-wave mixing process. Thus, random quasi-phase-matching in TM:II-VI laser gain media allows for simultaneous generation of short optical pulses at fundamental laser wavelength and at a number of secondary wavelengths produced due to the nonlinear frequency conversion. This feature of the polycrystalline TM:II-VI laser gain media is of importance for practical applications.

Mode-locked lasers utilizing the passive mode-locker (e.g. SESAM) usually exhibit so-called self-starting of the mode-locked laser regime, i.e. the laser starts to emit short pulses without any special assistance. KLM lasers usually exhibit difficulties with starting the mode-locked regime: after turning on, the laser emits continuous-wave radiation, and the emission of short pulses can be started only with an external intervention, e.g. by knocking or moving an optical component of the laser. The necessity of a mechanical intervention for starting the mode locked regime is impractical. Yet, many industrial applications could benefit from KLM lasers with a reliable starting mechanism.

The self-starting problem was addressed in the “Self-Starting Kerr-Mode-Locked Polycrystalline Cr²:ZnSe Laser” paper presented at CLEO (2008, OSA/C:LEO/QEL) and fully incorporated herein by reference. It discloses the use of TM:II-VI laser material in polycrystal form. Pumped by a CW linearly polarized Er fiber laser, the reported laser demonstrated promising results, such as self-starting Kerr-Mode-locked regime. However, at that time the industry did not have sufficiently sophisticated measuring equipment that could reliably confirm the mode-locked laser regime, the short pulse duration and the sustainability of the KLM.

A need therefore exists in a reliable and reproducible Kerr-lens mode locked femtosecond laser which is based on TM:II-VI materials and configured to minimize difficulties associated with known lasers.

### SUMMARY OF DISCLOSURE

This need is satisfied by the disclosed Kerr-lens mode-locked femtosecond laser based on polycrystalline TM:II-VI laser material (KLM polycrystalline TM:II-VI laser). The inventive laser is configured in accordance with the following aspects each of which individually or in combination with other aspects leads to a production of commercially viable femtosecond pulsed lasers in an about 1.8 to 8 micrometer wavelength range.

The disclosed laser includes, among others, a laser cavity with a gain medium, such as polycrystalline TM:II-VI material, at least one mirror on one side of the gain medium, and an output coupler that, together with the mirror(s), defines a light path in the laser cavity. The gain medium is positioned in the light path, and the output coupler has a loss profile for coupling out the light pulse as a function of wavelength across the 1.8-8 micrometer range of wavelengths.

In accordance with one aspect, the disclosed laser is further configured with a pump, which is used for the optical pumping of TM:II-VI gain medium at the desired wavelength. The pump may operate a continuous wave (CW) regime or pulsed regime and be configured as a MOPA (master oscillator/power amplifier) in which the emission of low power seed laser (CW or pulsed) is amplified in a chain of laser amplifiers.

The disclosed laser may be provided with a synchronous pumping of KLM polycrystalline TM:II-VI laser. In this scheme, the repetition frequency of the pump pulses equals inversed round trip time in the laser cavity and hence the repetition frequency of KLM polycrystalline TM:II-VI laser.

Alternatively, a quasi-synchronous pumping scheme of KLM polycrystalline TM:II-VI laser is implemented within the scope of this disclosure. In this scheme, the repetition frequency of the pump pulses is close but not necessarily equal to the repetition frequency of KLM polycrystalline TM:II-VI laser.

The controlled detuning between the repetition frequency of the pump pulses and the repetition frequency of KLM TM:II-VI laser allows for the laser emission spikes with the maximum intensity and hence the maximum probability of self-starting and sustaining the KLM regime after the initial start. The pulsed pumping of KLM TM:II-VI laser can be used only for starting KLM laser regime. Once the KLM regime of the inventive laser is started, the pump may operate in a continuous wave (CW) regime.

Thus, in contrast to the known prior art, the inventive laser may configured with all-optical and electronic means operative to start and stabilize the KLM regime in the TM:II-VI materials which preferably may include polycrystalline forms, but could also operate based on single-crystal form.

In accordance with another aspect of the disclosure, the inventive laser is configured so that the primary mechanism of the mode-locking—Kerr nonlinearity—is accompanied and affected by another nonlinear optical effect: three-wave mixing due to second order nonlinearity. The polycrystalline TM:II-VI materials utilized in the inventive laser exhibit relatively strong three-wave mixing effects due to random quasi-phase-matching.

Yet another aspect of the disclosure is concerned with a soliton mode-locked regime of the inventive laser. The soliton mode locking allows for stronger nonlinear phase shifts and enhances the stability of femtosecond pulses. The inventive laser is configured with a dispersion element creating an anomalous dispersion in the cavity necessary to enable the soliton regime.

Still a further aspect relates to a femtosecond (“fs”) amplifier based on TM:II-VI laser materials. The materials used for the disclosed amplifier include both single-crystal and polycrystalline forms.

### BRIEF DESCRIPTION OF THE DRAWINGS

The above and other aspects, features and advantages of the disclosure will become more readily apparent from the following drawings, in which:

FIG. 1 is an optical schematic of the inventive KLM laser;

FIG. 2A is a computer-generated image illustrating the optical triggering and sustaining of KLM in the disclosed laser of FIG. 1 observed after hands-off start of KLM.

FIG. 2B is a computer-generated image illustrating the optical triggering and sustaining of KLM in the disclosed laser of FIG. 1 with switching of the optical pump to a CW regime after the self-started KLM is manifested.

FIG. 3 is a computer-generated image illustrating optical triggering & sustaining of KLM in polycrystalline Cr:ZnSe laser of FIG. 1 with the pulse duration of 80-120 fs.

FIG. 4 is an optical schematic of the inventive laser similar to that of FIG. 1 but configured to operate in a self-starting and sustainable soliton locked regime.

FIG. 5 is a computer-generated image illustrating a soliton regime in polycrystalline Cr:ZnS of the inventive laser of FIG. 4.

FIG. 6A is a computer-generated plot emission spectrum of the inventive laser of FIG. 4.

FIG. 6B is a computer-generated emission spectrum of FIG. 6A in the logarithmic scale.

FIG. 7 is an optical schematic of the inventive KLM laser with the frequency doubling.

FIG. 8 is a computer-generated image of a femtosecond pulse train of the inventive KLM laser of FIG. 7.

FIG. 9 is an optical schematic of the fs amplifier based on TM:II-VI single and polycrystals.

FIG. 10 is an experimental demonstration of the fs pulse amplification in a single-pass Cr:ZnS amplifier.

FIG. 11 computer-generated images illustrating the autocorrelation traces obtained (top to bottom): for the fs oscillator, at the output of the amplifier stage with the amplifier's pump turned off, at the output of the amplifier stage at 5 W amplifier pumping, at the output of the amplifier stage at 10 W amplifier pumping.

FIG. 12 is an optical schematic illustrating a set up for measuring duration of ultrashort pulses by interferometry autocorrelator.

### DETAILED DESCRIPTION

Reference will now be made in detail to embodiments of the invention. Wherever possible, same or similar numerals are used in the drawings and the description to refer to the same or like parts or steps. The drawings are in simplified form and are not to precise scale. Unless specifically noted, it is intended that the words and phrases in the specification and claims be given the ordinary and accustomed meaning to those of ordinary skill in the fiber laser arts. The word “couple” and similar terms do not necessarily denote direct and immediate connections, but also include mechanical optical connections through free space or intermediate elements.

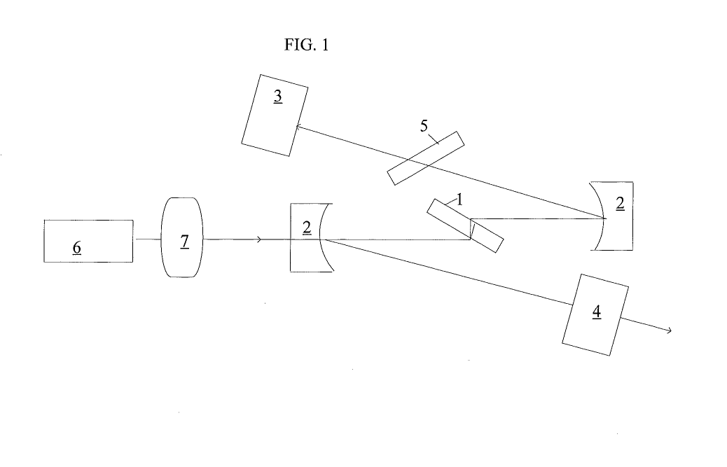

FIG. 1 illustrates rather one of many known configurations of the laser cavity (or resonator) for generating ultra-short pulses in a mid-IR spectral range known as a Z-shaped cavity. While the number of reflective elements may vary, the invariable part of it includes a gain element 1 placed inside the resonator. The laser cavity includes a high reflectivity arm defined between a high reflective (“HR”) plane mirror 3 HR and concave mirror 2, and a second arm delimited at opposite ends by another HR concave mirror 2 and a partially transmissive mirror 4. The mirror 4 is used as an output coupler (OC). The gain element is selected from II-VI materials doped with transition metals. Nonlimiting examples of suitable crystalline materials operating in a mid-IR wavelength range may include TM doped Zinc Selenide (“ZnSe”), Zinc Sulfide (“ZnS”), CdZnSe, CdZTe and other II-VI material that allow obtaining the laser emission in 1.8-8 micrometer spectral range.

In accordance with the main concept of the present disclosure, the above-mentioned and other II-VI materials when doped with transition metals, such as Chromium (Cr”), Iron (“Fe”) and other known to one of ordinary skilled worker, are capable of Kerr-lens mode locking (KLM)—useful mode locking technique which in very general terms may be summarized as follows: due to the Kerr effect, intense signals induce a nonlinear lens in the gain element. The laser cavity is adjusted such that more intense signals experience lower loss than less intense signals, and this intensity dependent loss enables a mode-locked regime of the laser.

Returning to FIG. 1, gain element 1 is made, for example, from a plane-parallel plate including Cr or Fe doped II-VI single crystal or polycrystalline semiconductor material, e.g. ZnSe, ZnS. The gain element 1 can be uncoated and Brewster mounted or AR coated and mounted at normal incidence. The mirrors 2 are configured as concave dielectric coated mirrors with high reflectivity at the desired laser wavelength and high transmission at a pump wavelength. The plain mirror 3 may be dielectric or metal coated and configured with high reflectivity at laser wavelength. The output coupler 4 is configured as a plane dielectric coated mirror with partial transmission at the laser wavelength.

Optionally, a dispersion compensation plate 5 is mounted in the laser resonator at the Brewster angle (plane-parallel plate made of fused silica, sapphire, yttrium aluminum garnet (YAG), or similar material). The dispersion compensation element works as a bulk element in which the dispersion is introduced by the material of the plate. Alternatively, the dispersive-compensation element can be configured as a pair of dispersive prisms.

Alternatively, the dispersive-compensation element may be configured as a dielectric mirror with a special multilayer dielectric coating providing the desired reflectivity band and a specific dependence of the group delay dispersion on the wavelength. Thus the dispersive mirror is more flexible than the plane-parallel plate or prism pair.

The pump 6 is configured as diode laser, bulk laser or fiber laser. The pump 6 can be configured as a MOPA consisting of a low power seed laser (CW or pulsed) and a chain of laser amplifiers. Finally, the beam shaping and focusing optics 7, which may be based on lenses or mirrors is configured to provide matching between the pump beam parameters and respective parameters of the laser beam inside the gain element 1. The laser shown in FIG. 1 may be pumped in three regimes: (i) continuous pumping, (ii) synchronous pulsed pumping, (iii) quasi-synchronous pulsed pumping.

The continuous pumping of TM:II-VI single and polycrystals, proper alignment of the laser resonator and proper management of the resonator's dispersion allow to obtain Kerr-lens mode-locked laser regime and hence efficiently convert the pump laser emission to ultra-short mid-IR output pulses in 1.8-8 μm spectral range. Properly aligned KLM laser usually emits continuous-wave radiation after being turned on. An external intervention (knocking or moving an optical component) is usually required to start the mode-locked regime of the laser.

As a specific example, the laser of FIG. 1 may include pump 6 configured as a CW Er fiber laser at 1567 nm, wherein gain element 1 is configured as a polycrystalline Cr:ZnSe. The gain element is AR coated and mounted at normal incidence. The laser resonator is properly aligned for the Kerr-lens mode-locked laser regime and resonator's dispersion is properly managed. After turning the pump, the laser emits CW radiation, and the mode-locked laser regime can be started by the translation of output coupler 4. After starting, the laser maintains the mode-locked regime for several days in a standard laboratory environment.

In the experiment involving the laser of FIG. 1, the parameters of continuously pumped polycrystalline Cr:ZnSe laser in Kerr-lens mode-locked regime of operation include the laser pulse train at 83 MHz pulse repetition frequency. Obtained autocorrelation trace corresponds to 44 fs lase pulse duration (about 5 optical cycles). Shapes of the autocorrelation trace and of the obtained laser emission spectrum reveal the high quality of the mode-locked laser emission: so-called time-bandwidth product of the laser pulses equals 0.32, which is very close to the theoretical limit of 0.315. The observed distortions in the laser emission spectrum are due to air absorption in mid-IR spectral range.

In the regime of synchronous pumping the repetition frequency of the pump pulses fₚᵤₘₚ exactly matches the inversed round trip time in the laser resonator fₗₐₛₑᵣ:fₚᵤₘₚ=fₗₐₛₑᵣ=c/2L, where c is the speed of light, L is the length of the resonator. The synchronization of two repetition rates is implemented either by precisely adjusting the pump repetition rate or by precise adjustment of the laser resonator length (e.g. one of the resonator's mirrors can be placed on a translation stage or controlled by a piezo-transducer). It the regime of quasi-synchronous pumping the repetition frequency of the pump pulses fₚᵤₘₚ is close to, but not necessarily equal to Amer.

Under synchronous pumping, a certain fraction of the laser emission, which circulates in the resonator, passes through the gain element 1 simultaneously with the pump pulse every roundtrip. Such a synchronization (and proper alignment of the resonator) results in the formation of the laser pulse and significant reduction of the laser pulse duration in comparison with the pump pulse duration.

The synchronous pumping of TM:II-VI single and polycrystals allows to (i) efficiently convert ns or sub-ns pump pulses to ps mid IR output pulses in the 1.8-8 μm spectral range; and (ii) efficiently convert fs pump pulses to ultra-short few cycle fs output pulses in the 1.8-8 μm spectral range. Proper alignment of the resonator and management of its dispersion would be necessary in the latter case.

As a specific example, the laser of FIG. 1 may include pump 6 configured as an Er:YAG pump source at 1645 nm, 200 ps pulse duration and 160 MHz pulse repetition rate, wherein gain element 1 is configured as a polycrystalline Cr:ZnSe gain element, mounted at Brewster angle. The pulse duration of the synchronously pumped Cr:ZnSe laser was about 2 ps (factor of 100 reduction).

Furthermore, the synchronous and quasi-synchronous pumping of TM:II-VI single and polycrystals allows starting the Kerr-lens mode locked laser regime without external intervention (knocking or moving an optical component). Mode-locked starts from a spike in the intensity fluctuations of a free-running laser. The spike with high enough intensity can occur due to a random intensity fluctuation. In case of continuous pumping, the spike is usually produced, and the KLM laser regime is started by a mechanical “kick” to the laser resonator. An environmental disturbance may result in disruption of the KLM laser regime and necessity for a restart.

The laser shown in FIG. 1 can be configured with all-optical and electronic means for starting and stabilization of the Kerr-Lens Mode-lock (KLM) regime of TM: II-VI lasers. The pump is pulsed and configured for synchronous or quasi-synchronous pumping. The repetition frequency of the pump pulses fₚᵤₘₚ is close but not necessarily equal to fₗₐₛₑᵣ.

Intensity fluctuations of the illustrated KLM laser, while it is not running in the mode-locked regime, occur at the multiples of the frequency fₗₐₛₑᵣ. The interplay between the pump modulation frequency and the intensity fluctuations frequency results in appearance of spikes in the laser intensity and hence in starting of the KLM laser regime. Proper detuning of fₚᵤₘₚ from fₗₐₛₑᵣ allows for the spikes with the maximum intensity and hence the maximum probability of the KLM regime starting. Exact value of the detuning depends on the parameters of the laser resonator and of the gain element. The modulation of the pump laser emission can be kept on after the starting thus ensuring the automatic restart of the KLM regime after its disruption.

The synchronous and quasi-synchronous pumping schemes can be implemented by (i) the pulsed pump laser with controllable pulse repetition rate and/or (ii) the intensity modulation of the CW pump laser (if necessary, the modulated output of the low-power CW pump laser can be amplified in a laser amplifier).

An example of the quasi-synchronous schemes with the controllable repetition rate may include the Er:YAG pump source operating at 1645 nm, 200 ps pulse duration and 160 MHz pulse repetition rate. In the intensity modulation configuration, the emission of low power semiconductor laser at 1550 nm is modulated by electro-optic-optic intensity modulator and amplified in Er fiber amplifier. Polycrystalline Cr:ZnSe and Cr:ZnS gain elements were used as the KLM laser medium. By proper alignment of the resonator, the hands-off start and long-term operation of Cr:ZnSe KLM laser in both pumping regimes (pulsed pumping and modulated pumping) have been repeatedly obtained.

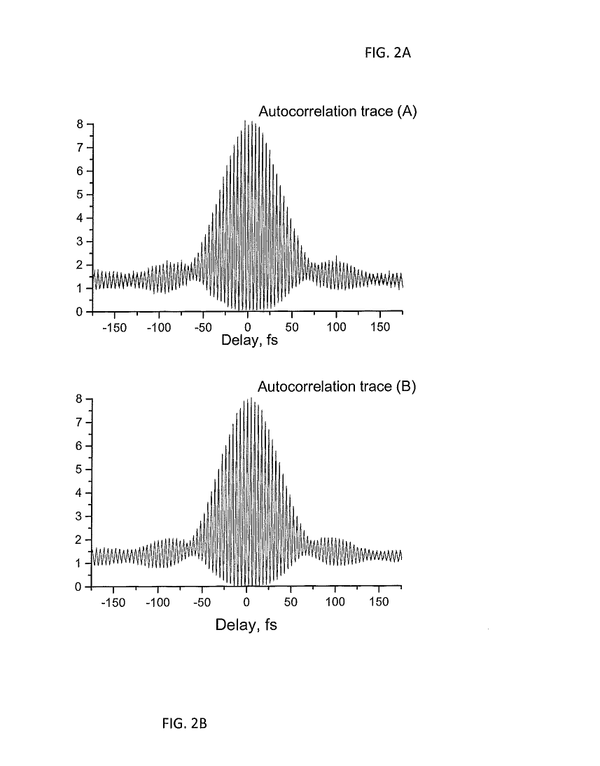

FIGS. 2A and 2B illustrate the experimental example of optical self-start and sustainability of the KLM in Cr:ZnSe laser with the quasi-synchronous pumping scheme. The autocorrelation trace A of FIG. 2A is obtained after the hands-off start of the KLM under the quasi-synchronous pumping with experimentally optimized detuning between the pump pulse repetition rate and the laser cavity round trip. The autocorrelation trace B of FIG. 2B is obtained after the hands-off start of the KLM under quasi-synchronous pumping and subsequent switching of the pump laser to CW regime. As can be seen the KLM regime is maintained after switching of the pump from the pulsed regime to CW regime.

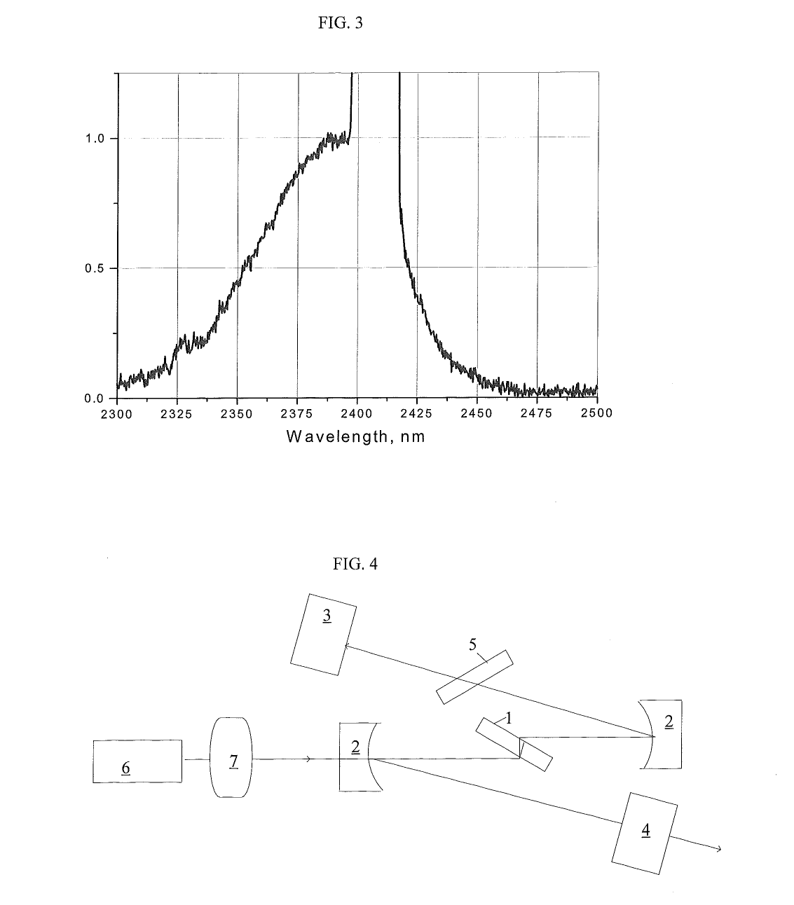

FIG. 3 is the computer generated plot illustrating both optical triggering and sustaining of the KLM in Cr:ZnSe laser with the quasi-synchronous pumping scheme. The KLM laser emission spectrum is obtained after hands-off start of KLM under quasi-synchronous pumping. As can be seen, the obtained autocorrelation trace and broad laser emission spectrum confirm KLM laser operation with the pulse duration of 80-120 fs. Reproducing

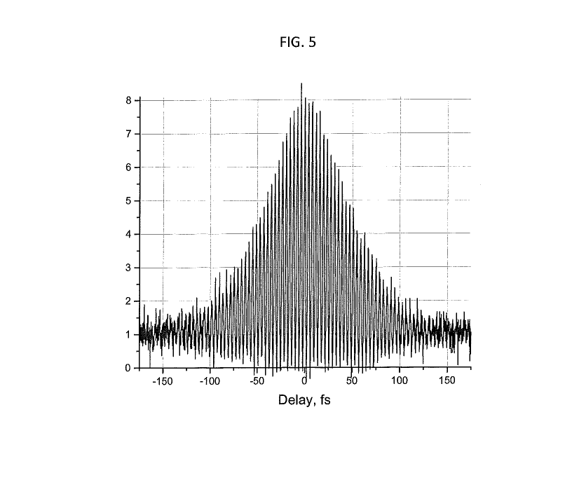

Referring to FIG. 4, the inventive laser of FIG. 1 is also configured to start and maintain soliton KLM regime. The configuration of the illustrated laser includes gain element 1 configured as a plane-parallel plate made of polycrystalline Cr doped ZnS. The gain element 1 can be uncoated and Brewster mounted or AR coated and mounted at normal incidence. The concave dielectric coated mirror 2 exhibits high reflectivity at the desired laser wavelength and high transmission at the given pump wavelength. The plane mirror 3 is configured with the high reflectivity at the given laser wavelength (dielectric or metal coated). The output coupler 4 is a plane dielectric coated mirror with partial transmission at the given laser wavelength). The laser may have optional dispersion compensation element 5. The pumping schemes may involve the schemes implemented in the embodiments of FIG. 1.

FIG. 5 illustrates the computer generated image of the soliton KLM regime in polycrystalline Cr: ZnS. The shape of obtained autocorrelation trace corresponds to the transform-limited sech² pulses.

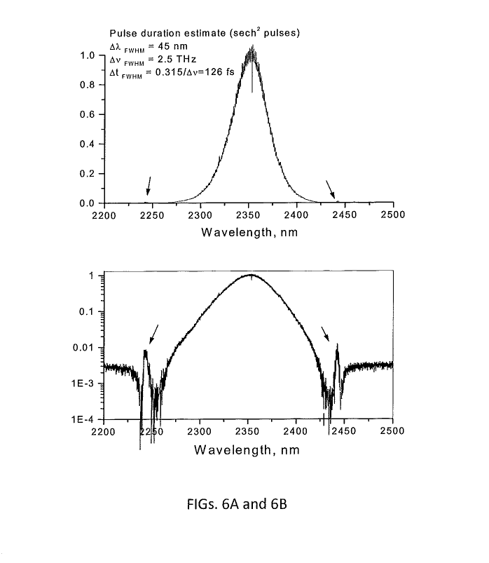

FIGS. 6A and 6B illustrate the soliton KLM regime in polycrystalline Cr:ZnS. The plot of FIG. 6A shows the obtained laser emission spectrum and the plot of FIG. 6B shows the same spectrum on a logarithmic scale. The shape of the spectrum and presence of Kelly sidebands are the evidence of the soliton mode locking with the transform limited sech² pulses of 126 fs pulse duration.

FIG. 7 illustrates the inventive laser configured so that the primary mechanism of the mode-locking Kerr nonlinearity in the polycrystalline TM:II-VI medium is accompanied and affected by another nonlinear optical effect: second harmonic generation due to random quasi-phase-matching in the polycrystalline TM:II-VI medium. The schematic is configured as follows: the gain element 1 (polycrystalline TM:II-VI material) can be uncoated and Brewster mounted or AR coated and mounted at normal incidence. The concave dielectric coated mirror 2 with high reflectivity at laser wavelength and high transmission at pump wavelength. The plane minor 3 is configured with a high reflectivity coating at laser wavelength which can be either dielectric or metal. The output coupler 4 is configured as a plane dielectric coated mirror with partial transmission at laser emission wavelength. The KLM laser output 8 is emitted at the fundamental wavelength, whereas the KLM laser output 9 at the second harmonic is partially transmitted through minor 3 and detected by a photodetector 10, which is sensitive to the laser radiation at second harmonic wavelength. The polycrystalline TM:II-VI gain medium 11 consists of multiple microscopic grains of various sizes and orientations.

The efficiency of SHG in nonlinear materials is limited by dispersion, i.e., the difference in velocity of light propagation at a fundamental laser wavelength and at a second harmonic (SH) wavelength. Therefore, the energy transfer from a fundamental wave to the SH wave occurs at a limited length of the nonlinear material known as coherence length (CL). In most materials CL is of the order of few tens of um resulting in weak SHG efficiency. The techniques that allow circumventing this limit have been developed. Traditional techniques are based on birefringence of some nonlinear crystals. More recent developments are based on engineering of the microscopic structure of the nonlinear material (quasi phase matching or QPM). Standard QPM crystals contain regular patterns, optimized for most efficient nonlinear frequency conversion at certain laser wavelengths, e.g. they have limited bandwidth. More sophisticated patterning allows for the increased bandwidth, which is accompanied by a decrease of the overall conversion efficiency.

The polycrystalline TM:II-VI gain medium consists of microscopic single-crystal grains. The specifically developed technological process allows producing polycrystalline TM:II-VI samples with a grain size, which is of the order of the coherence length of SHG process in middle IR wavelength range (30-60 um, depending on the wavelength and the material type). Thus the TM:II-VI gain medium can be patterned like standard QPM material. Unlike in the standard QPM material, the patterning is not perfect but randomized (there are dissimilarities in the grain size and in orientation of the crystallographic axes). This randomization of the patterning results in low SHG efficiency (if compared with standard QPM material). However the randomization allows for SHG in very broad spectral range i.e. very large bandwidth.

The property of polycrystalline TM:II-VI gain medium is of importance for fs mode-locked laser applications: (i) weak SHG efficiency of the material is compensated by a very high peak power of fs laser, (ii) very large SHG bandwidth of polycrystalline TM:II-VI gain medium allows for SHG of the whole emission spectrum of the fs laser (30 nm and more, depending on the laser regime.)

It is known that the mode-locked regime of the laser oscillations can be achieved by means of the second harmonic generation (SHG) in specially optimized nonlinear crystal inserted in the laser resonator. It was shown that a combination the SHG crystal and one of the resonator's mirrors (so called frequency doubling nonlinear mirror or NLM) is equivalent to a saturable absorber, suitable to enable mode locking. Usually the lasers with NLM as a primary mode locker operate in ps regime. Here a fs laser is described with the primary mode locking mechanism being Kerr lens nonlinearity which is accompanied and affected by SHG process. Particular feature of the laser is the use of the same polycrystalline TM:II-VI material as the laser gain medium, Kerr lens mode locker, and SHG nonlinear converter.

The two important features of polycrystalline TM:II-VI gain medium with random QPM are: (i) interplay between Kerr lens nonlinearity in the material (primary mode locking mechanism) and SHG in the material (secondary mode locking mechanism) allows for more stable mode locked laser operation, (ii) secondary output of the mode-locked fs laser at second harmonic wavelength can be used as the indicator of the fs laser regime. The SHG signal is at the noise level in the absence of the mode lock but rather pronounced and easily detectable by a low-cost near IR photodetector if the laser is mode locked and produce fs pulses.

The detected SHG signal can be used in a feed-back loop for active stabilization of the fs laser (repetition rate, output power etc.). Detection of near IR SHG signal is advantageous over signal detection at the fundamental mid IR wavelength because of significantly better performance and lower cost of fast photodetectors for the near IR band. Furthermore, the intensity of the SHG signal is proportional to the square of optical intensity at fundamental mid IR wavelength. Such a nonlinear response of the SHG signal to the fluctuations of the fs laser intensity allows for generation of more pronounced error signals and hence increases the performance of the feed-back loop.

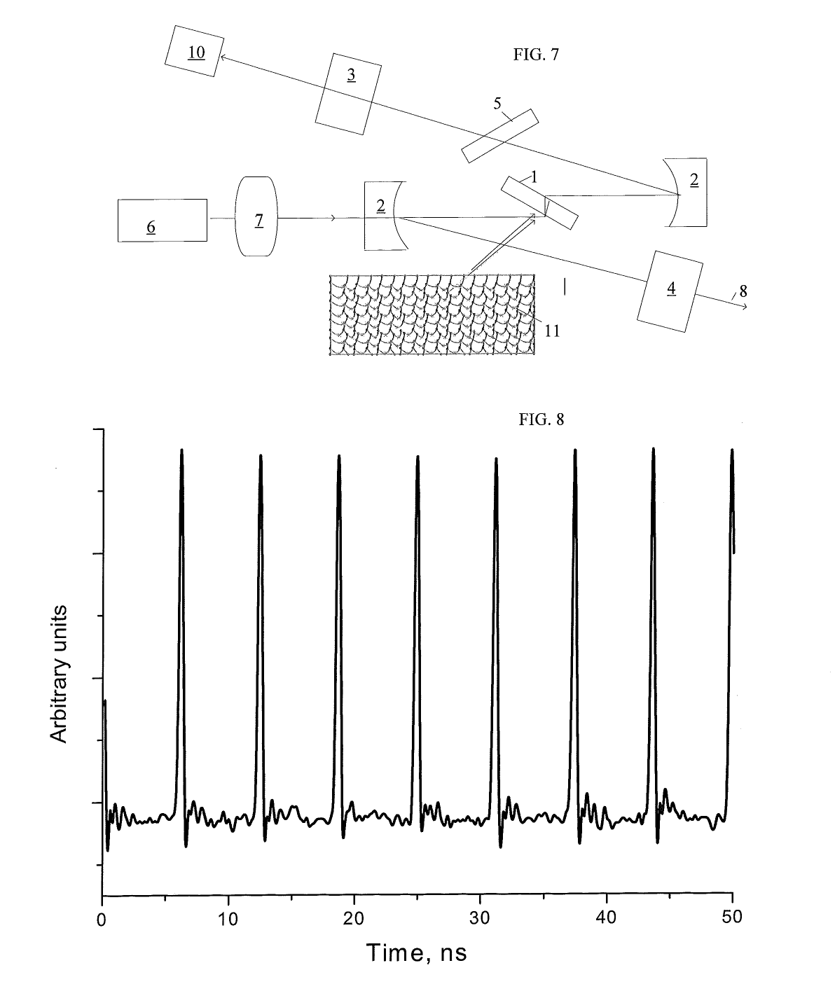

Turning to FIG. 8 in addition to FIG. 7, a femtosecond pulse train of the inventive KLM laser with self-frequency doubling realized via random quasi-phase matching in the polycrystalline TM:II-VI gain medium is shown. The optical signal at the SH wavelength is detected at a secondary SHG output of the laser in FIG. 7 with a photo detector 10, which is placed outside the laser cavity and configured to be sensitive at the SHG wavelength (about 1200 nm) but insensitive at the fundamental laser wavelength (about 2400 nm). The measured pulse width is limited by response time of the photo detector (about 0.5 ns). Actual duration of the fs pulses can be measured indirectly using the autocorrelator, as discussed herein below.

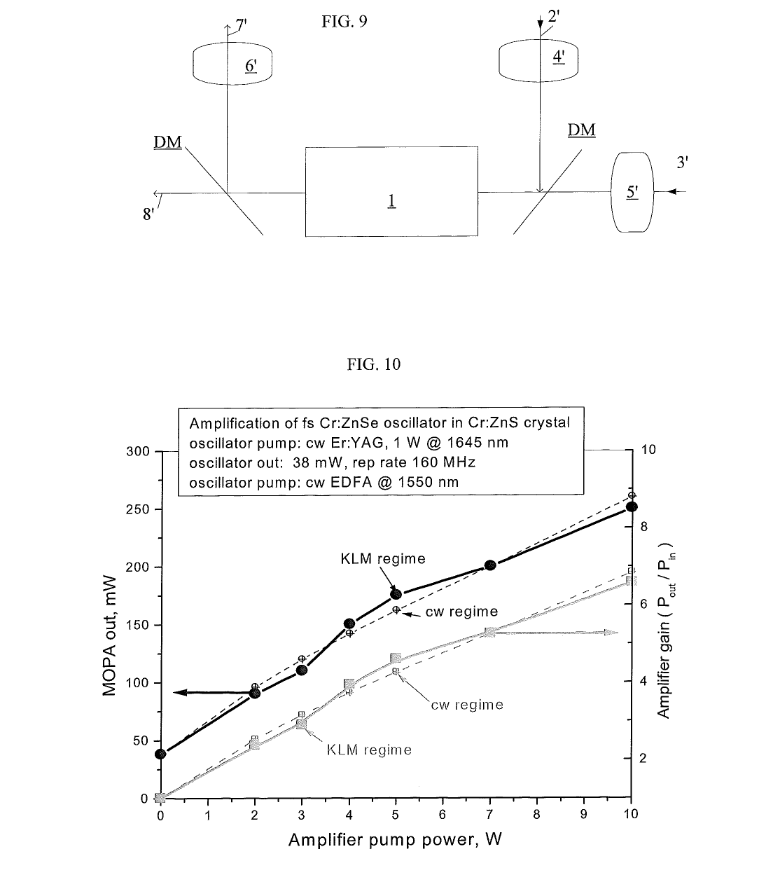

FIG. 9 illustrates a femtosecond single pass amplifier based on TM:II-VI single and polycrystals. The fs amplifier is based on gain element 1 configured with TM:II-VI single and polycrystals. The gain element 1 can be uncoated and Brewster mounted or AR coated and mounted at normal incidence. The gain element 1 can be plane-parallel cut or wedged; DM—dichroic dielectric coated mirror with high reflectivity at fs laser wavelength and high transmission at pump laser wavelength (or vice versa). The reference 2′ denotes a fs laser beam. The reference 3′—input pump laser beam; 4′—beam shaping and focusing optics for input fs laser beam (based on lenses or mirrors); 5′—beam shaping and focusing optics for input pump laser beam (based on lenses or mirrors); 6′—beam shaping and focusing optics for output fs laser beam (based on lenses or mirrors); 7′—output fs laser beam; 8′—output pump laser beam.

The beam shaping and focusing optics and the dichroic mirror for the input fs and pump beams can be combined e.g. beam combining on a dichroic mirror and focusing of the combined beam by the same lens or focusing of the fs beam by curved dichroic mirror and focusing of the pump beam by a separate lens.

The fs laser source may be configured in accordance with all of the disclosed embodiments of FIGS. 1, 4 and 7. Alternatively, the disclosed laser may be any mid-IR fs laser source (bulk, semiconductor, or fiber-based).

The pump 6 shown in FIGS. 1, 4 and 7 and also used in FIG. 9 may be configured as CW or pulsed fiber laser doped with Er or Tm. Alternatively, the pump 6 may be any laser source (bulk, semiconductor, or fiber-based), which emission wavelength is suitable for pumping of TM:II-VI laser materials.

As a specific example, the femtosecond single pass amplifier of FIG. 9 may include the pump configured as a continuous wave Er fiber laser at 1567 nm, gain element 1 configured as a polycrystalline Cr:ZnS. The gain element 1 is AR coated and mounted at normal incidence. FIG. 10 illustrates the parameters of the described configuration of femtosecond single pass amplifier, The horizontal axis indicates the amplifier pump power, left vertical axis (black curves) indicates output fs laser power; right vertical axis (green curves) indicates the amplifier gain. Solid lines/solid symbols indicate the results obtained for fs input signal, dashed lines/open symbols indicate the results obtained for CW laser at the same central wavelength, beam parameters and average power. As can be seen the efficiency of fs signal amplification is the same as for CW signal with the same parameters. Thus, a part of CW pump power is efficiently converted to the fs pulses.

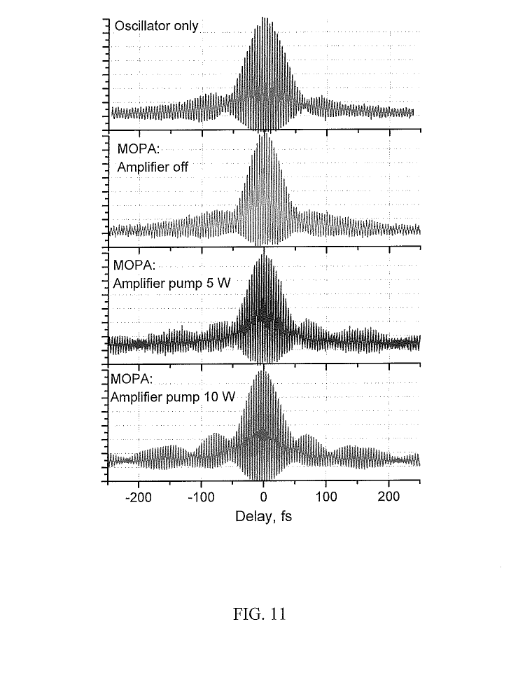

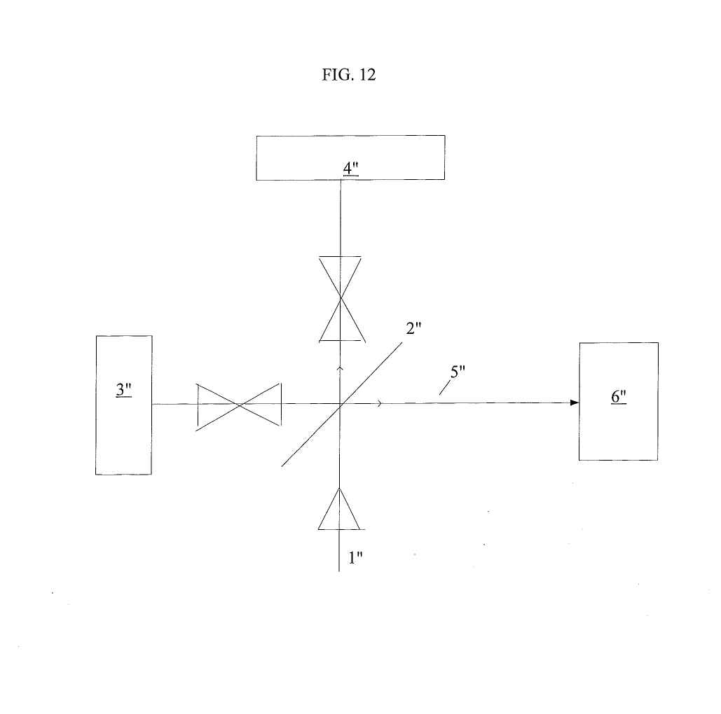

FIG. 11 illustrates the comparison of the autocorrelation traces obtained (top to bottom): for the fs oscillator, at the output of the amplifier stage with the amplifier's pump turned off, at the output of the amplifier stage at 5 W amplifier pumping, at the output of the amplifier stage at 10 W amplifier pumping.

The obtained results clearly show that the amplifier stage maintains the fs laser regime in a range of the amplifier pump power. Observed differences in the shape of the autocorrelation traces are the evidence of the fs pulse distortions due to the dispersion in the gain element. The dispersion of the gain element and hence the observed temporal distortions can be compensated by a standard means (i.e. by an additional dispersion compensation stage based on gratings, prisms or dispersive mirrors.)

FIG. 13 illustrates a measuring technique reliably detecting the above-disclosed experimental data. In particular, the illustrated interferometric autocorrelator is characterized by the incoming beam1, a splitter 2″, mirrors 3″ and 4″, and reference 5″ denotes the superposition of the two copies of the incoming beam. Finally reference 6″ denotes a nonlinear detector.

The basic principle of operation of an autocorrelator for a pulse duration measurement can be explained as following: A special mirror with 50% reflectivity and 50% transmission (so called beam splitter, BS) creates two copies of the input laser pulse. These two copies are superimposed in a nonlinear medium by means of two mirrors. The Strength of the nonlinear interaction is high if the two copies of the pulse overlap temporarily and low if the overlap does not occur. A typical 100 fs laser pulse has a spatial extent of about 30 μm. Therefore even a small displacement of one of the autocorrelator mirrors allows detuning the autocorrelator from the perfect spatial and temporal overlap of the two copies of the incoming pulse. Thus, scanning of the mirror around the position, which corresponds to the perfect overlap, allows to measure the spatial extent of the pulse and hence its duration. Thus, very short pulse durations can be measured with slow photodetector: the detector only has to measure an average power (assuming that a regular pulse train is sent into the autocorrelator).

All the features disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. Any feature, whether preferred or not, may be combined with any other feature, whether preferred or not.

The reader's attention is directed to all papers and documents which are filed concurrently with this specification and which are open to public inspection with this specification, and the contents of all such papers and documents incorporated herein by reference.

1. (canceled)

2. A sub-nanosecond mode-locked laser comprising:
at least two reflective elements defining a resonant cavity therebetween;
a laser gain element (“GE”) placed inside the resonant cavity, the GE being selected from transition metal doped II-VI materials; and
an optical pump emitting a pulsed output to synchronously pump the GE at a pulse repetition rate frequency fₚᵤₘₚ, the pump being configured so that the fₚᵤₘₚ substantially matches an inversed round trip time in the resonant cavity fₗₐₛₑᵣ:fₚᵤₘₚ≈fₗₐₛₑᵣ=c/2L, where c is the speed of light, L is the length of the resonant cavity, wherein the synchronous pumping triggers and sustains a short-pulse emission of the laser with picosecond or femtosecond pulse durations.

3. (canceled)

4. The laser of claim 2, wherein the optical pump is configured so that fₚᵤₘₚ is selected to be within ±10% of the fₗₐₛₑ.

5. The laser of claim 2, wherein optical pump is configured to trigger and sustain a Kerr Lens mode (“KLM”).

6. The laser of claim 2, wherein the GE element includes
transition metals selected from Chromium (“Cr”), Iron (“Fe”) and Cobalt (“Co”) and,
TM:II-VI having a single-crystal form or polycrystalline forms and including Chromium doped zinc Selenide (“Cr:ZnSe”), Chromium doped Zinc Sulfide (“Cr:ZnS”), Cr doped Cadmium Selenide (Cr:CdSe), Chromium doped Cadmium Sulfide (Cr:CdS), iron doped Zinc Selenide (Fe:ZnSe), Iron doped Zinc Sulfide (Fe:ZnS), Iron doped Cadmium Selenide (Fe:CdSe), Iron doped Cadmium Sulfide (Fe:CdS), Iron doped Cadmium Tellurium (Fe:CdTe), ternary or quaternary iron doped II-VI GE.

7-8. (canceled)

9. The laser of claim 2, wherein the pump is configured as a laser selected from bulk or fiber lasers operative to output pulses in a picosecond-femtosecond duration range.

10. The laser of claim 2 further comprising at least one dispersion compensation element placed within the resonant cavity and configured to provide a soliton mode-locking regime, the dispersion element including a plane parallel plate (YAG, fused silica sapphire) or a plurality of dispersion compensation prisms or a plurality of dispersive mirrors, wherein the dispersion mirrors each are configured with a multilayer coating selected to provide a desired reflectivity band and a selected dependence of a group delay dispersion on a wavelength.

12. (canceled)

11. (canceled)

12. (canceled)

13. The laser of claim 2, wherein the GE is configured in a polycrystalline form having a pattern of non-uniform single crystal grains, the pattern and averages size of the single crystal grains being selected to provide for a random quasi-phase-matched three-wave mixing phenomenon selected from the group which consists of second harmonic generation (SHG), sum-frequency generation (SFG), difference frequency generation (DFG) and optical rectification (OR) and a combination of these in the GE, and to selectively maximize the yield of the SHG, SFG, DFG, or OR.

14. The laser of claim 13 further comprising an IR photodetector located outside the resonant cavity and configured to detect the SHG, wherein the detection of the SHG is an indicator of the KLM across emission spectra of the laser.

15. The laser of claim 13 further comprising a feedback loop configured to guide a signal corresponding to the detected SHG to dynamically stabilize the KLM regime.

16. A femtosecond single pass laser amplifier operative to amplify the emission of the mode-locked mid-IR laser of claims 1-15, comprising:
the laser gain element (“GE”) selected from transition metal doped polycrystalline or single-crystal II-VI materials;
the optical pump emitting continuous or discontinuous output; and
at least one optical element operative to superimpose and focus the pump beam and the mode-locked mid-IR laser beam in the GE, the at least one optical element or system being operative to separate and collimate the laser beams at the output of GE.

17-19. (canceled)

20. The laser amplifier of claim 16, wherein the optical pump is configured as a laser selected from semiconductor, bulk or fiber lasers.

21. The laser amplifier of claim 16, wherein the optical pump is configured as a pulsed nanosecond, a picosecond or a femtosecond laser.

22. (canceled)
